(19) United States
(12) Patent Application Publication
(10) Pub. No.: US 2026/0133339 A1
(43) Pub. Date: May 14, 2026

(54) SYSTEM AND METHOD FOR MONITORING A SNOWPACK, AND USE OF THE SYSTEM

(71) Applicant: Zygizo AS, STAVANGER (NO)

(72) Inventor: Trond Spande, STAVANGER (NO)

(73) Assignee: Zygizo AS, STAVANGER (NO)

(21) Appl. No.: 19/118,975

(22) PCT Filed: Oct. 10, 2023
(86) PCT No.: PCT/NO2023/060066

§ 371 Date: Apr. 7, 2025

(30) Foreign Application Priority Data
Oct. 12, 2022 (NO) 20221096

(51) Int. Cl. G01V 3/16; G01V 1/30; G01V 3/17; G01V 3/38

(52) U.S. Cl. CPC G01V 3/16; G01V 1/301; G01V 3/17; G01V 3/38; G01V 2210/6163

(57) ABSTRACT

A system and a method for monitoring a snowpack formed from an accumulation of snow layers. The system includes: at least one device for transmitting electromagnetic signals and acoustic signals and recording wavefields of the transmitted signals as function of time, each device being installable under the snowpack; a remotely operated aircraft for transmitting electromagnetic signals and recording wavefields of the transmitted signals, the remotely operated aircraft being moveable to an aircraft location above the snowpack; and a data processing system for receiving recorded wavefields from the at least one device and the remotely operated aircraft. Also disclosed is a use of the system for monitoring a snowpack.

### CROSS-REFERENCE TO RELATED APPLICATIONS

This application is the U.S. national stage application of International Application No. PCT/NO2023/060066, filed Oct. 10, 2023, which international application was published on Apr. 18, 2024, as WO 2024/080878 in the English language. The International Application claims priority to Norwegian Patent Application No. 20221096 , filed Oct. 12, 2022. The international application and Norwegian application are both incorporated herein by reference, in their entirety.

### FIELD

The present invention relates to a system for monitoring a snowpack formed from an accumulation of snow layers. The present invention also relates to a method of monitoring a snowpack formed from an accumulation of snow layers. Also, the present invention relates to a use of the system.

### BACKGROUND

Nowadays, assessing the formation and stability of snowpacks is an important field of study. Gathering knowledge about the physical properties of snow under different conditions and their evolution is useful in activities such as prediction and mitigation of avalanches and predicting water discharge.

A snowpack typically forms from layers of snow that accumulate in geographic regions and high elevations where the climate includes cold weather for extended periods during the year. Snowpacks are an important water resource that feeds streams and rivers as they melt. Therefore, snowpacks are both the drinking water source for many communities and a potential source of flooding (in case of sudden melting). Snowpacks are also an important supply of water for generating electrical power and they can contribute mass to glaciers in their accumulation zone.

Measuring physical paraments of snow can be done manually in situ. However, this approach is disadvantageous for several reasons, such as that it requires having personnel on site, is prone to human error, and, due to the effort required, the measurements are normally not done as often nor as extensively as it would be preferred. A preferred alternative involves using remote sensors. Typically, remote sensing can be done in an automatic, non-invasive, cost effective and accurate manner. Also, remote sensing allows repeating measurements, working day and night and creating a continuous record of the snow thickness, density, and structure.

It can be challenging to use remote sensors for monitoring a snowpack both accurately and in big areas, e.g. with at least 100 km² (square kilometer).

Typically, known approaches using remote sensors include positioning the sensors above the snow level and obtaining measurements facing downwards. This looking-downwards approach often leads to drawbacks. Firstly, the sensors themselves are susceptible to avalanches, weather, vandalism, and excessive interference/noise. Secondly, determining the snow thickness can be difficult due to the requirement of knowing the ground type (e.g. hard rock, clay, sand, grass, etc.), which is often unknown. Each ground type typically results in a different response for the sensors. Thirdly, in many cases, time is required to perform manual calibration, processing, and interpretation and may result in information about the snow which is mostly of a qualitative type and not of a quantitative type, such as porosity, compliance, layer thickness.

Another known approach relates to the use of FM-radar, which is well known since at least the 1970s. However, the FM-radar approach is sensitive to wet snow. This type of sensitivity makes this approach useful for snow melt detection (e.g. wet avalanche forecasting), but it also makes the detection being limited to dry snow and, therefore, it is not recommended for monitoring snow water equivalence (SWE) or liquid-water content (LWC).

A further known approach is disclosed in EP 2290397 A1, which describes a system for non-destructive analysis of a snow layer, the system being positioned under a snowpack and including both electromagnetic (EM) and acoustic transmitters and receivers. Placing the system under the snowpack is advantageous in avoiding the problems with the ground type. Also, the use of acoustic signals in addition to the EM signals allows dealing with the limitations of the FM-radar approach to non-dry snow conditions. However, this solution has several drawbacks when used in big areas. Most of the embodiments disclosed for this solution include a rail system for placing and moving the transmitters and receivers under the snowpack being monitored. FIG. 2 in EP 2290397 A1 shows a tunnel that has been built under a snowpack. In practice, this approach requires enormous efforts to implement and maintain. Also, this difficulty is significantly increased when scaling up the implementation, making it unfeasible to perform an implementation over big areas with at least 100 km² . There is also an important concern in that such an approach has a significant impact on the environment, which is highly undesirable.

### SUMMARY

The invention will now be disclosed and has for its object to remedy or to reduce at least one of the drawbacks of the known prior art, or at least provide a useful alternative to the known prior art. The object is achieved through features, which are specified in the description below and in the claims that follow. The invention is defined by the independent patent claims, and the dependent claims define advantageous embodiments of the invention.

According to a first aspect of the invention, there is provided a system for monitoring a snowpack formed from an accumulation of snow layers. The system comprises:
at least one device for transmitting first electromagnetic signals and first acoustic signals and recording wavefields of the transmitted first electromagnetic signals and first acoustic signals as a function of time, each device being installable at a respective device location under the snowpack; and
a data processing system comprising a network interface for receiving recorded wavefields from the at least one device.

The system further comprises:
a remotely operated aircraft comprising an electromagnetic transceiver for transmitting second electromagnetic signals and recording wavefields of the transmitted second electromagnetic signals as a function of time, the remotely operated aircraft being moveable above the snowpack to an aircraft location.

Also, the data processing system and the remotely operated aircraft are adapted for wirelessly transmitting recorded wavefields from the remotely operated aircraft to the data processing system.

The use of the at least one device under the snowpack and the remotely operated aircraft movable above the snowpack achieves a synergistic advantage that allows monitoring the snowpack both without limitation to dry snow and with a reduced implementational and maintenance effort over an area covered by a snowpack. This dual advantage makes the system favorable for monitoring snowpacks disposed over big areas, such as at least 100 or 200 km² , while achieving reliable wavefield recordings for estimating the current state of the snowpack.

Optionally, the remotely operated aircraft is configured to move within a geographical area covering at least one device location. Thus, it is possible to implement a reduced number of device locations while providing the remotely operated aircraft to record reflections at locations between and around device locations. The reduced number of device locations, on its own, would be unfeasible to monitor an area of a snowpack that can be monitored by also including the remotely operated aircraft. However, the system requires less devices to be provided under the snow and is still capable of monitoring the entirety of the area covered by the snowpack.

Optionally, the network interface of the data processing system is a wireless interface and each of the at least one device comprises a wireless network interface so that the data processing system wirelessly receives recorded wavefields from the at least one device. Thus, a simpler configuration is achieved for the data channels between the data processing system and the at least one device installed under the snowpack. It is also advantageous in that less effort is required to add devices or change a device's position without requiring cable management operations.

Optionally, each of the at least one device comprises a battery for supplying electricity. Thus, the installation of a device has a reduced impact on the environment as it does not require a severe change to accommodate power supplying cables.

Optionally, each of the at least one device comprises at least one transceiver set, each transceiver set comprising:
an electromagnetic transceiver for emitting and receiving first electromagnetic signals;
an acoustic emitter for emitting first acoustic signals; and
an acoustic sensor for recording the first acoustic signals.

Optionally, each device is configured to arrange the at least one transceiver set in any of: a line; at least two parallel lines; a cross; a circle; or a square. Depending on the transceiver set arrangement, the device is more suited for recording estimations along one or a combination of directions. For example, if the arrangement is a two-dimensional shape, such as a cross, a circle, or a square, the system will be suited for processing estimations along an area.

Optionally, the at least one device comprises at least two, at least three or at least four devices.

Optionally, the system is configured to carry out the steps of:
operating each of the at least one device at a respective device location to record wavefields of first electromagnetic signals and first acoustic signals as a function of time and transmit the recorded wavefields of the first electromagnetic signals and the first acoustic signals to the data processing system;
operating the remotely operated aircraft at an aircraft location to record wavefields of second electromagnetic signals as a function of time and transmit the recorded wavefields of the second electromagnetic signals to the data processing system.

According to a second aspect of the invention, there is provided a method of monitoring a snowpack formed from an accumulation of snow layers. The method comprises the steps of:
providing a system as described in the first aspect of the invention;
installing each of the at least one device at a respective device location under the snowpack;
operating each of the at least one device to record wavefields of first electromagnetic signals and first acoustic signals as a function of time and transmit the recorded wavefields of the first electromagnetic signals and the first acoustic signals to the data processing system;
operating the remotely operated aircraft to move within a geographical area covering at least one device location, the remotely operated aircraft recording wavefields of second electromagnetic signals as a function of time at an aircraft location and transmitting the recorded wavefields of the second electromagnetic signals to the data processing system;
operating the data processing system to receive recorded wavefields from the at least one device and the remotely operated aircraft; and
operating the data processing system to update a virtual model of the snowpack.

Optionally, the step of operating the data processing system to update a virtual model of the snowpack comprises the step of estimating a snow water equivalence (SWE) and/or a Liquid Water Content (LWC) of the snowpack as a function of depth at the aircraft location. Thus, the estimation of the SWE and/or LWC can be useful for, e.g., estimating water discharge.

Optionally, the step of operating the data processing system to update a virtual model of the snowpack comprises the step of estimating a shear strength, porosity and/or density of the snowpack as a function of depth at the aircraft location. In the case of shear strength, its estimation can be useful for, e.g., predicting avalanches.

Optionally, the step of operating the remotely operated aircraft comprises operating the remotely operated aircraft to move in a grid pattern to cover the geographical area. Thus, the remotely operated aircraft can be configured to carried out in a way that is consistent and repeatable.

Optionally, the method further comprises any of the steps of:
repeating the step of operating each of the at least one device so that the data processing system receives updated recorded wavefields from each of the at least one device; and/or
repeating the step of operating the remotely operated aircraft so that the data processing system receives updated recorded wavefields from the remotely operated aircraft, and wherein the method further comprises the step of:
operating the data processing system to update the virtual model of the snowpack based on the updated recorded wavefields.

Thus, the method can be carried out to initialize a virtual model of the snowpack and, after that, periodically update the virtual model based on new recordings from any of the devices and/or the remotely operated aircraft. Therefore, it is possible to maintain an accurate model of the snowpack over time without requiring substantial infrastructure and operations.

According to a third aspect of the invention, there is provided a use of a system according to the first aspect of the invention, wherein the system is used for monitoring a snowpack.

### BRIEF DESCRIPTION OF THE FIGURES

In the following, a description is provided for examples of preferred embodiments illustrated in the accompanying drawings, wherein:

FIG. 1 shows a schematic view of a system embodiment including a device and a remotely operated aircraft;

FIG. 2a shows a schematic side view of reflection paths from an acoustic emitter to a plurality of acoustic sensors of the device shown in FIG. 1;

FIG. 2b shows a schematic graph of sensor data obtained from the reflection experiment illustrated in FIG. 2a; and

FIG. 3 shows a schematic perspective view of part of another system embodiment including two devices and one remotely operated aircraft.

### DETAILED DESCRIPTION

The drawings are shown in a schematic and simplified manner, and features that are not necessary for explaining the invention may be left out. Identical reference numerals refer to identical or similar features in the drawings. The various features shown in the drawings may not necessarily be drawn to scale.

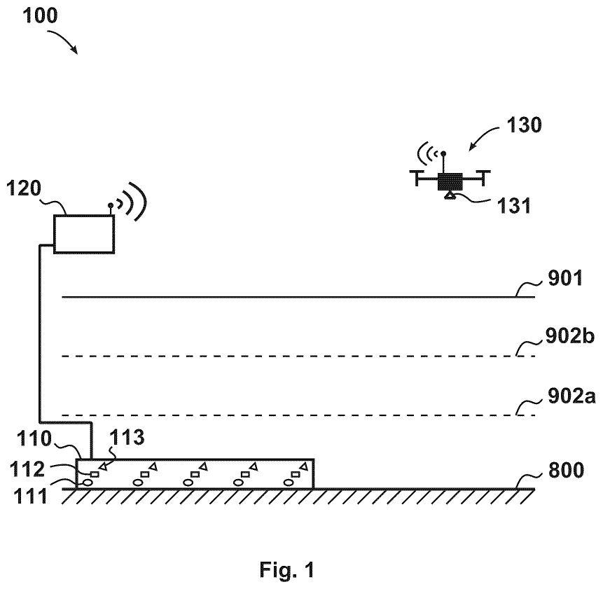

Turning now to FIG. 1, it shows an example usage of a system embodiment 100 installed for monitoring a snowpack. For illustrative purposes, the portion of the snowpack illustrated in FIG. 1 includes three horizontal snow layers accumulated on a ground 800. A bottom snow layer is shown on top of the ground 800. An intermediate snow layer is based on the top surface of the first layer 902a. And the top snow layer is based on the top surface of the intermediate layer 902b and delimited at the top by the snow surface 901.

The system 100 includes a device 110 for transmitting electromagnetic signals and acoustic signals and recording wavefields of the transmitted signals as a function of time. In the example usage shown in FIG. 1, the device 110 is installed under the snowpack and on the ground 800. The device embodiment 110 in FIG. 1 is shown as having an elongated body along a main axis parallel to the ground 800 (the elongation of the device 110 is illustrated horizontally in FIG. 1).

To record wavefields of electromagnetic signals and acoustic signals, the device 110 includes a plurality of transceiver sets, each transceiver set including an electromagnetic transceiver 111 for emitting and receiving electromagnetic signals towards/from the snowpack, an acoustic emitter 112 for emitting acoustic signals towards the snowpack, and an acoustic sensor 113 for receiving acoustic signals from the snowpack. The transceiver sets are arranged along the main axis of the elongated body of the device 110. Thus, the arrangement of transceiver sets is arranged in parallel to the ground 800.

The system 100 also includes a data processing system 120 for receiving recorded wavefields from the device 110. In the embodiment shown in FIG. 1, the data processing system 120 is implemented as a single data processing device that is connected to the device 110 by a wire (observable on the left-hand side of FIG. 1). The data processing system 120 also includes a wireless network interface for communicating wirelessly.

Also, the system 100 includes a remotely operated aircraft 130 (observable on the top right corner of FIG. 1), which in the embodiment shown in FIG. 1 is illustrated as a drone 130. The drone 130 includes a wireless network interface for communicating with the data processing system 120 and an electromagnetic transceiver 131 for transmitting electromagnetic signals and recording wavefields of the transmitted signals as a function of time. The drone 130 is configured to fly and move above the snowpack while recording wavefields with the electromagnetic transceiver 131 pointed downwards to the snowpack. The data processing system 120 and the drone 130 are configured to communicate with each other so that the recorded wavefields from the drone 130 are wirelessly transmitted to the data processing system 120.

Therefore, the system 100 is capable of gathering recorded wavefields at the data processing system 120, both originating from the device 110 installed at fixed locations under the snowpack and from the drone 130 moving above the snowpack.

Although FIG. 1 shows one usage example, the skilled person will find other possible implementations for the system 100 without requiring inventive skills. For example, the device 110 is illustrated as being placed on the ground 800, which can be achieved by installing it prior to the first snow fall. Should this installation not be possible in practice, the system 100 will also be useful while having the at least one device 110 installed on top of already existing snow layers, while having other snow layers accumulated above it. Alternatively, a system embodiment 100 may also be installed so that it provides the at least one device 110 as being installed under a road, under ice in a frozen lake, or some other location that is expected to be covered by an accumulation of snow.

Moreover, the data processing system 120 can be implemented in different manners. In an advantageous implementation, the main computing resources of the data processing system 120 are provided at a remote location (e.g. a datacenter), in the form of a server or a cloud-based service involving at least one server. This approach is advantageous in that it makes it efficient to perform data intensive tasks off-site while keeping the local elements of the system 100 with a reduced power consumption and mainly configured to record wavefields and transmit them to the remote part of the data processing system 120.

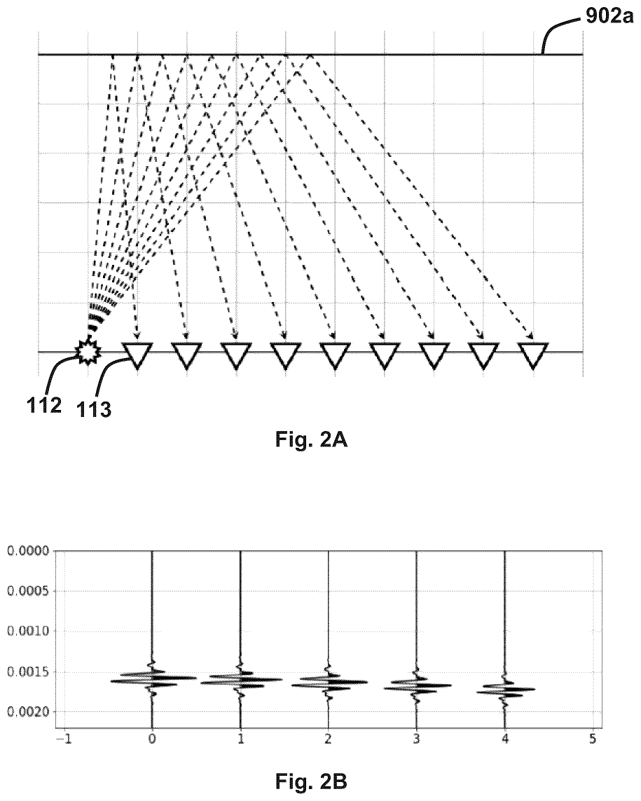

FIG. 2a shows a side view of reflection paths that are observed for an acoustic emitter 112 and a plurality of acoustic sensors 113 of the device 110 shown in FIG. 1. One acoustic emitter 112 is shown at one end of the device 110 (observable on the bottom left corner in FIG. 2a), and the plurality of acoustic sensors are observable in a regular linear arrangement along the main axis of the elongated body of the device 110. At the top of FIG. 2a, the top surface 902a of the bottom snow layer is shown.

When the acoustic emitter 112 is activated, an acoustic signal will travel in many directions starting from the acoustic emitter 112 and into the bottom snow layer of the snowpack. Reflections will then occur where there is an abrupt contrast in elasticity, in the case of sound, or dielectric permittivity, in the case of electro-magnetism. In practice, it is observable that the reflection intensity will be stronger when the elastic and/or dielectric contrast is more abrupt. Typical reflections in snow result from interfaces between old and new snow and the interface between snow and air. In a simplified manner as shown in FIG. 2A, when the acoustic signal reaches the top surface 902a of the bottom snow layer, i.e. the interface 902a between the bottom and the intermediate snow layers, a reflection of at least part of the acoustic signal will occur with a higher intensity than on the rest of the bottom snow layer. That reflection will redirect at least part of the acoustic signal back towards the device 110, as shown by the dashed arrows in FIG. 2a.

FIG. 2b shows a schematic graph of sensor data obtained from the reflection experiment illustrated in FIG. 2a. When the reflected acoustic signal reaches the acoustic sensors 113 linearly arranged along the elongated body of the device 110, the recordings shown in the graph in FIG. 2b are observed. The vertical axis of the graph represents a time axis with the delay since the acoustic signal was emitted, and the horizontal axis represents the signal magnitude measured at the horizontal positions of each acoustic sensor 113. As shown, the acoustic sensors 113 receive the reflected acoustic signal at different delays. These delay differences depend on the distance that has to be traveled by the acoustic signal in order to reach the acoustic sensor 113. Therefore, the acoustic sensor 113 positioned closer to the acoustic emitter 112 will be the first to detect the reflected acoustic signal, whereas the acoustic sensor 113 positioned farthest away from the acoustic emitter 112 will be the last to detect the reflected acoustic signal.

The device 110 is thus capable of sensing the top surface of the bottom snow layer 902a based on at least the any of the following: the constant relative positions of the transceiver sets of the device 110; the delay between the emission and reception of a signal; the time differences between detection at different sensors; and the distortion observed in a detected signal, such as in the amplitude and/or frequency domain(s). The skilled person will know many ways of processing the data received by the EM-transceivers 111 and acoustic sensors 113 so that the various elastic and/or dielectric contrasts in the snowpack may be sensed and analyzed.

For illustrative purposes, the illustrations in FIG. 2a-2b are focused on the emission and sensing of acoustic signals. However, similar concepts may be applied to the emission and sensing of electromagnetic signals. Moreover, the illustration in FIG. 2a is focused on reflections observed on the top surface of the bottom snow layer, however in practice many more reflections can be observed depending on the conditions of the entire snowpack. Furthermore, the example shown in FIG. 2a does not exclude the possibility of having other non-inventive combinations of emitter 111,112 and receivers 111,113 being used in the same device 110.

While using both electromagnetic and acoustic signals, the device 110 records wavefields of both electromagnetic signals and acoustic signals on and/or within the snowpack as a function of time at a device location. The skilled person will be able to define the device location in a preferable manner. For example, the device location may be defined as the average location of the locations of all emitters 111,112 of a device 110.

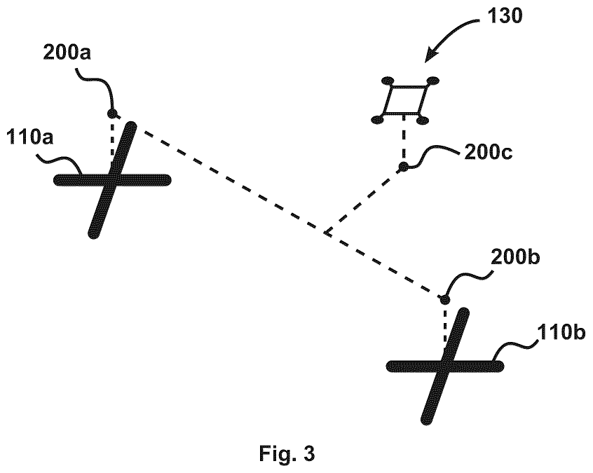

FIG. 3 shows a schematic perspective view of part of another system embodiment for monitoring a snowpack formed from an accumulation of snow layers. The system includes two devices 110a,110b installed under the snowpack and a remotely operated aircraft 130, which in this system embodiment is also a drone 130. The drone 130 is movable above the snowpack.

For illustrative purposes, the snowpack has been hidden. Also, the device locations 200a,200b and the aircraft location 200c are illustrated as dots on the (not shown) surface of the snowpack. As shown, the device locations 200a,200b are illustrated above the respective devices 110a,110b and the aircraft location 200 c is illustrated under the drone 130.

As shown in FIG. 3, each device 110a,110b is shaped as a cross. Each device 110a,110b includes a plurality of transceiver sets that is arranged in the cross shape, and this arrangement allows each device 110a,110b to record wavefields along a two-dimensional profile. For practical purposes, each device location 200a, 200b has been defined as being the location above the center of the cross, although the skilled person will find other options for defining the device location 200a, 200b. Also in this embodiment, the aircraft location 200c has been defined as the point on the surface of the snowpack that is under the center of the drone 900.

The two devices 110a,110b shown in FIG. 3 are spaced apart over at least 10 Km and the drone 900 is flying at an aircraft location 200c that is both between the two device locations 200a,200b and deviated from an invisible line connecting the two device locations 200a,200b.

The system also includes a data processing system (not shown in FIG. 3). The data processing system is configured to, firstly, initialize a virtual model of the snowpack and, secondly, periodically update the virtual model based on new recordings from the two devices 110a,110b and/or the drone 130.

After the system is provided on site and each of the devices 110a,110b have been installed at respective device locations 200a,200b under the snowpack, the virtual model of the snowpack can be initialized as follows:
Each of the devices 110a,110b is operated to record wavefields of electromagnetic signals and acoustic signals as a function of time and transmit the recorded wavefields to the data processing system.
The drone 130 is operated to move within a geographical area covering both device locations 200a,200b. The drone 130 records wavefields of electromagnetic signals as a function of time at an aircraft location 200c and transmits the recorded wavefields to the data processing system.
The data processing system receives recorded wavefields from the two devices 110a,110b and the drone 130 and updates a virtual model of the snowpack.

After its initialization, the virtual model can be periodically updated based on new recordings from the devices 110a,110b and/or the drone 130, which is achieved as follows:
The step of operating the each of the devices 110a,110b is repeated so that the data processing device receives updated recorded wavefields from each of the devices 110a,110b; and/or
The step of operating the drone 130 is repeated so that the data processing device receives updated recorded wavefields from the drone 130.
The virtual model of the snowpack is updated based on the updated recorded wavefields.

The skilled person will find different ways for processing the recorded wavefields received by the data processing system. For the recorded wavefields received from a device, one option may be to estimate the seismic and electromagnetic velocities as a function of depth along the snowpack above the device. Empirical relations between the velocities and the densities may then be used for obtaining an estimate of the snow density as a function of the depth along the snowpack. An initial density profile is typically smooth and further processing can be used for refining the density estimates and adding sharp components of the density contrasts. Example methods for a such further processing are impedance inversion, amplitude-variation-with-offset (AVO) inversion and full waveform inversion (FWI). For the recorded reflections received from a remotely operated aircraft, one option may be to convert the reflection travel-times to depth using the velocity information estimated from the devices.

The data processing system can process virtual models of the snowpack in several ways. For example, one option is to generate a virtual model of the snowpack based on estimates of a snow water equivalence (SWE) and/or a Liquid Water Content (LWC) of the snowpack as a function of depth at the aircraft location 200c. Another option may be to generate a virtual model of the snowpack based on estimates of a shear strength, porosity and/or density of the snowpack as a function of depth at the aircraft location. Also, the skilled person will find that these and other options may be combined when generating a virtual model of the snowpack.

From the description above with regard to how the recorded wavefields may be processed by the data processing system, it can be observed that the recording of wavefields and the processing of the recorded wavefields do not have to be done in real time. Instead, the transmission of recorded wavefields may happen first and the processing of the recorded wavefields can happen at a later time.

It should be noted that the above-mentioned embodiments illustrate rather than limit the invention, and that those skilled in the art will be able to design many alternative embodiments without departing from the scope of the appended claims. For example, the solutions described above may be used for monitoring a snowpack covering less than 100 km² (square kilometer). In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

1.-14. (canceled)

15. A system for monitoring a snowpack covering at least one hundred km2, the snowpack being formed from an accumulation of snow layers,
wherein the system comprises:
at least one device for transmitting first electromagnetic signals and first acoustic signals and recording wavefields of the transmitted first electromagnetic signals and first acoustic signals as a function of time, each device being installable at a respective device location under the snowpack; and
a data processing system comprising a network interface for receiving recorded wavefields from the at least one device,
wherein the system further comprises:
a remotely operated aircraft comprising an electromagnetic transceiver for transmitting second electromagnetic signals and recording wavefields of the transmitted second electromagnetic signals as a function of time, the remotely operated aircraft being moveable above the snowpack to an aircraft location, and
wherein the data processing system and the remotely operated aircraft are adapted for wirelessly transmitting recorded wavefields from the remotely operated aircraft to the data processing system.

16. The system according to claim 15, wherein the remotely operated aircraft is configured to move within a geographical area covering at least one device location.

17. The system according to claim 15, wherein the network interface of the data processing system is a wireless interface and each of the at least one device comprises a wireless network interface so that the data processing system wirelessly receives recorded wavefields from the at least one device.

18. The system according to claim 15, wherein each of the at least one device comprises a battery for supplying electricity.

19. The system according to claim 15, wherein each of the at least one device comprises at least one transceiver set, each transceiver set comprising:
an electromagnetic transceiver for emitting and receiving first electromagnetic signals;
an acoustic emitter for emitting first acoustic signals; and
an acoustic sensor for recording the first acoustic signals.

20. The system according to claim 19, wherein each device is configured to arrange the at least one transceiver set in any of: a line; at least two parallel lines; a cross; a circle; or a square.

21. The system according to claim 15, wherein the at least one device comprises at least two, at least three or at least four devices.

22. The system according to claim 15, wherein the system is configured to carry out the steps of:
operating each of the at least one device at a respective device location to record wavefields of first electromagnetic signals and first acoustic signals as a function of time and transmit the recorded wavefields of the first electromagnetic signals and the first acoustic signals to the data processing system;
operating the remotely operated aircraft at an aircraft location to record wavefields of second electromagnetic signals as a function of time and transmit the recorded wavefields of the second electromagnetic signals to the data processing system.

23. Use of a system according to claim 15, wherein the system is used for monitoring a snowpack.

24. A method of monitoring a snowpack formed from an accumulation of snow layers, the method comprising the steps of:
providing a system as described in claim 15;
installing each of the at least one device at a respective device location under the snowpack;
operating each of the at least one device to record wavefields of first electromagnetic signals and first acoustic signals as a function of time and transmit the recorded wavefields of the first electromagnetic signals and the first acoustic signals to the data processing system;
operating the remotely operated aircraft to move within a geographical area covering at least one device location, the remotely operated aircraft recording wavefields of second electromagnetic signals as a function of time at an aircraft location and transmitting the recorded wavefields of the second electromagnetic signals to the data processing system;
operating the data processing system to receive recorded wavefields from the at least one device and the remotely operated aircraft; and
operating the data processing system to update a virtual model of the snowpack.

25. The method according to claim 24, wherein the step of operating the data processing system to update a virtual model of the snowpack comprises the step of:
estimating a snow water equivalence (SWE) and/or a Liquid Water Content (LWC) of the snowpack as a function of depth at the aircraft location.

26. The method according to claim 24, wherein the step of operating the data processing system to update a virtual model of the snowpack comprises the step of:
estimating a shear strength, porosity and/or density of the snowpack as a function of depth at the aircraft location.

27. The method according to claim 24, wherein the step of operating the remotely operated aircraft comprises operating the remotely operated aircraft to move in a grid pattern to cover the geographical area.

28. The method according to claim 24, wherein the method further comprises any of the steps of:
repeating the step of operating each of the at least one device so that the data processing system receives updated recorded wavefields from each of the at least one device; and/or
repeating the step of operating the remotely operated aircraft so that the data processing system receives updated recorded wavefields from the remotely operated aircraft, and
wherein the method further comprises the step of:
operating the data processing system to update the virtual model of the snowpack based on the updated recorded wavefields.

29. The method according to claim 25, wherein the step of operating the data processing system to update a virtual model of the snowpack comprises the step of:
estimating a shear strength, porosity and/or density of the snowpack as a function of depth at the aircraft location.

30. The method according to claim 25, wherein the step of operating the remotely operated aircraft comprises operating the remotely operated aircraft to move in a grid pattern to cover the geographical area.

31. The method according to claim 26, wherein the step of operating the remotely operated aircraft comprises operating the remotely operated aircraft to move in a grid pattern to cover the geographical area.

32. The method according to claim 25, wherein the method further comprises any of the steps of:
repeating the step of operating each of the at least one device so that the data processing system receives updated recorded wavefields from each of the at least one device; and/or
repeating the step of operating the remotely operated aircraft so that the data processing system receives updated recorded wavefields from the remotely operated aircraft, and
wherein the method further comprises the step of:
operating the data processing system to update the virtual model of the snowpack based on the updated recorded wavefields.

33. The method according to claim 26, wherein the method further comprises any of the steps of:
repeating the step of operating each of the at least one device so that the data processing system receives updated recorded wavefields from each of the at least one device; and/or
repeating the step of operating the remotely operated aircraft so that the data processing system receives updated recorded wavefields from the remotely operated aircraft, and
wherein the method further comprises the step of:
operating the data processing system to update the virtual model of the snowpack based on the updated recorded wavefields.

34. The method according to claim 27, wherein the method further comprises any of the steps of:
repeating the step of operating each of the at least one device so that the data processing system receives updated recorded wavefields from each of the at least one device; and/or
repeating the step of operating the remotely operated aircraft so that the data processing system receives updated recorded wavefields from the remotely operated aircraft, and
wherein the method further comprises the step of:
operating the data processing system to update the virtual model of the snowpack based on the updated recorded wavefields.
